(19) United States
(12) Patent Application Publication
(10) Pub. No.: US 2008/0067135 A1
(43) Pub. Date: Mar. 20, 2008

(54) Automatic control system for chlorine in chillers

(76) Inventors: W. Neal Stanford, Conyers (GE); James D. Stanford, Conyers (GE)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/804,289

(22) Filed: May 17, 2007

Related U.S. Application Data
(60) Provisional application No. 60/801,115, filed on May 17, 2006.

(51) Int. Cl. C02F 1/76; C02F 1/38

(52) U.S. Cl. 210/754; 210/360.1

(57) ABSTRACT

Automatic control systems for chlorine in chillers.

To the full extent permitted by law, the present application claims priority to and the benefit as a non-provisional application to provisional application entitled “Automatic Control System for Chlorine in Chillers” filed on May 17, 2006, having assigned U.S. Provisional Ser. No. 60/801,115, wherein said application is incorporated herein by referenced.

### BACKGROUND

I. Field of the Invention

The present invention relates generally to the field of control systems for chlorine, and more particularly for an automatic control system for chlorine in chillers.

II. Description of the Related Art

Chiller tanks are commonly used to keep food products cool during processing. Examples of food products include, but are not limited to poultry, meat and vegetables. Such cooler tanks include a level of cooling water as well as chlorine to reduce pathogen levels in the chiller water.

During the stay within the cooling water, debris from the food product as well as debris on the food products fall into the chiller water and can contaminate chlorine sensors in the chiller tank, which monitor the chlorine levels within the chiller water, and can therefore provide false readings.

### SUMMARY

In general, the invention features an automatic control system for chlorine in chillers. In general, in poultry processing poultry is often kept in chiller water tanks to keep the poultry cool during processing. In order to reduce pathogens and other contaminants, it is desirable to keep a level of chlorine in the chiller water. The present system is an automatic control system to monitor the chlorine levels in the chiller water and to maintain chlorine levels. Referring to the enclosed drawings, the system operates generally as follows. A certain amount of chiller water is diverted from a chiller to a tank. In a typical implementation, compressed air is injected in the bottom of the tank. This compressed air separates the fat from the water. The fat then flows out of a drain in the top of the tank. The separated chiller sample water is then pumped from the bottom of the 20-gallon circular tank and pushed through a centrifugal-action filter. The water then enters a flow cell and runs across a chlorine probe that is connected to a chlorine analyzer. The chlorine analyzer reads the PPM chlorine level in the sample water and sends an electronic signal to a chart recorder. Another output signal is sent from the chlorine analyzer to a variable speed pump. The variable speed pump injects more or less of a Cal-Hypo Stock Solution into the “red water” system of the chiller so that consistent free chlorine residuals can be obtained, measured, and recorded.

In general, the invention features an automatic control system for chlorine in chillers, the system including a chiller tank for cooling food products, a chlorine source coupled to the chiller tank and a chlorine analysis center coupled to the chiller tank and to the chlorine source.

In one implementation, the chiller tank is coupled to the chlorine source via a water supply line.

In another implementation, the chiller tank is coupled to the chlorine analysis center via a water sample line.

In another implementation, the chlorine source and the chlorine analysis center are coupled via a signal line.

In another implementation, the chlorine source comprises a supply line connected to a chlorinator and to a mixing tank.

In another implementation, the system further includes a variable speed pump disposed between the mixing tank and the chiller tank.

In another implementation, the system further includes a signal line disposed between the variable speed pump and the chlorine analysis center.

In another implementation, the chlorine analysis center includes a chlorine analyzer coupled to the chlorine source and a debris tank coupled to the chiller tank and to the chlorine analyzer.

In another implementation, the system further includes a pump disposed between the chlorine analyzer and the debris tank.

In another implementation, the system further includes a centrifugal action filter disposed between the chlorine analyzer and the debris tank.

In another implementation, the system further includes a flow meter disposed between the chlorine analyzer and the debris tank.

In another implementation, the system further includes a flow cell disposed between the chlorine analyzer and the debris tank.

In still another implementation, the system further includes a chlorine probe disposed between the flow cell and the chlorine analyzer.

In yet another implementation, the system further includes a chart recorder coupled to the chlorine analyzer.

In another implementation, the system further includes a drain coupled to the debris tank for receiving sample water and debris overflow from the debris tank.

In another implementation, the system further includes a compressed air source coupled to the debris tank for providing compressed air into a water sample contained within the debris tank.

In another aspect, the invention features a system for removing debris from a chlorine sample for testing of chlorine levels, the system including a chiller water tank, means for providing chlorine to the chiller water tank and means for analyzing levels of chlorine contained within the chiller water tank.

In one implementation, the system further includes means for varying a flow of chlorine into the chiller tank.

In another implementation, the system further includes means for removing debris from water samples fed to the means for analyzing levels of chlorine contained within the chiller water tank.

One advantage of the invention is that consistent chlorine levels can be accurately recorded and maintained within food product processing chiller tanks.

Another advantage of the invention is that debris and fat levels can be removed from chiller tanks.

Another advantage of the invention is that food processing systems are not interrupted during the recording and maintenance of chlorine levels within chiller tanks.

Another advantage of the invention is that the systems and methods can be adapted to many different food product processing systems.

Other objects, advantages and capabilities of the invention are apparent from the following description taken in conjunction with the accompanying drawings showing the preferred embodiment of the invention.

### BRIEF DESCRIPTION OF THE DRAWINGS

FIG. 1 illustrates a perspective view of an embodiment of an automatic control system or chlorine in chillers.

### DETAILED DESCRIPTION

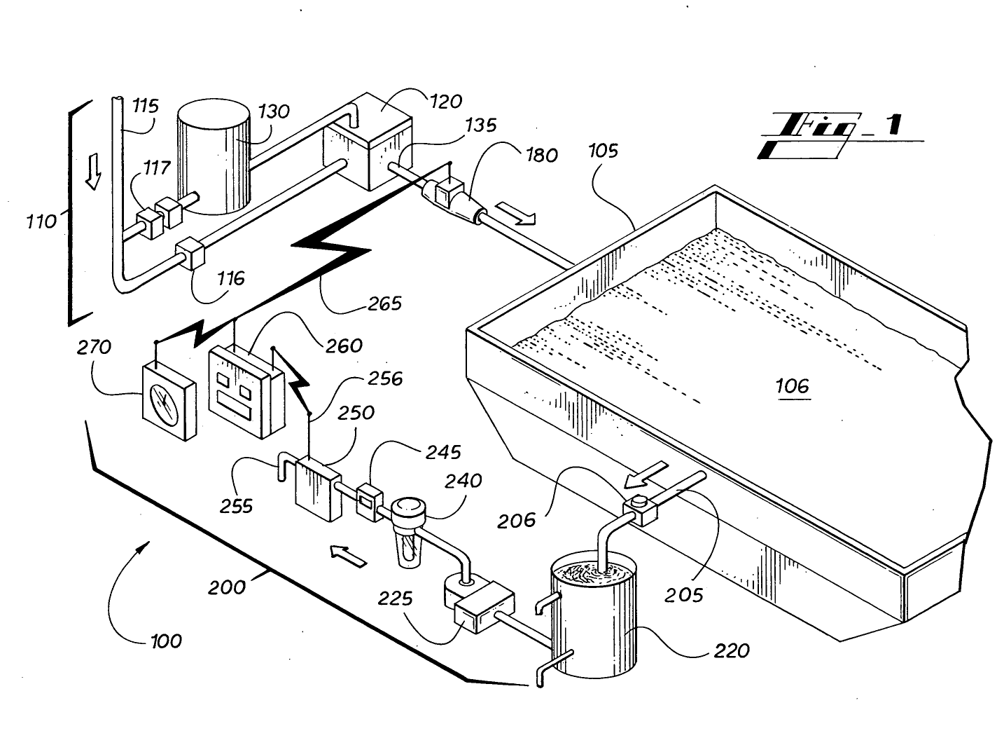

Referring to the drawings wherein like reference numerals designate corresponding parts throughout the several figures, reference is made first to FIG. 1 that illustrates a perspective view of an embodiment of an automatic control system 100 for chlorine in chillers.

In general, as discussed above in food product processing food product is often kept in chiller water tanks to keep the food product cool during processing. In order to reduce pathogens and other contaminants, it is desirable to keep a level of chlorine in the chiller water. The present system is an automatic control system to monitor the chlorine levels in the chiller water and to maintain chlorine levels.

In a typical embodiment, the system 100 includes chiller tank 105 coupled to a chlorine source 110. Chiller tank 105 typically includes chiller water 106. Chiller tank 105 is further coupled to chlorine analysis center 200.

In a typical embodiment, chlorine analysis center 200 includes a sample conduit 205 having control valve 206 for controlling the flow of the sample from the chiller water 106. Tank 210 is disposed on one end of sample conduit 205. Compressed air source 220 is disposed adjacent the bottom of tank 210 for supplying compressed air into a collected sample of chiller water 106 held within tank 210. Drain 230 is generally disposed adjacent the top of tank 210. Drain 230 for carrying debris from the sample of chiller water 106. Pump 225 is disposed between tank 210 and centrifugal action filter 240. Pump 225 generally pumps the sample of chiller water 106 from tank 210 to centrifugal action filter 240. In a typical implementation, digital flow meter 245 can be connected upstream of centrifugal action filter 240 for measuring flow rate in chlorine analysis center 200.

Chlorine analysis center 200 further can include flow cell 250 for controlling the flow rate of the sample water within chlorine analysis center 200. Flow cell 250 further includes drain 255 for allowing run off or overflow of the sample of chill water 106 to drain from chlorine analysis center 200. Chlorine analysis probe 256 is disposed within flow cell 250 for measuring chlorine levels within the chiller water sample. Chlorine analysis probe 256 is coupled to chlorine analyzer 260. Chlorine analyzer 260 is coupled to chart recorder 270. Chlorine analyzer 260 is further coupled to chlorine source 110, specifically to variable speed pump 180.

In a typical embodiment, chlorine source 110 includes water supply line 115 that branches to two sections: one section 116 to chlorine mixing tank 120, and second section 117 to chlorinator 130. Ultimately two sections 116, 117 both flow into mixing tank 120 and into line 135. The chlorinated water supply is pumped through line 135 via variable speed pump 180 as discussed above. In general, coupling line 265 from chlorine analyzer 260 controls the speed of variable speed pump 180. Thus depending on the level of chlorine sampled from chiller water 106, the pump speed of variable speed pump 180 can be varied via signal across coupling line 265 from chlorine analyzer 260.

During operation, in a typical implementation, 2 gpm of chiller water 106 is diverted from the chiller 105 to a 20-gallon circular tank 210. Compressed air source 220 injects compressed air into the bottom of circular tank 210. This compressed air can be used to separate fat from poultry and meat sources from chiller water 106 or general debris from other food products and forces the fat/debris to the top of the water held within tank 210. The fat or other debris then flows out of a drain 230 in the top of circular tank 210.

The separated chiller sample water is then pumped from the bottom of the 20-gallon circular tank 210 and pushed through centrifugal-action filter 240. The water enters flow cell 250 and runs across chlorine probe 256 that is connected to chlorine analyzer 260.

Chlorine analyzer 260 reads the PPM chlorine level in the sample water and sends an electronic signal to a chart recorder 270 via coupling line 275. It is appreciated that chart recorder 270 can be advantageously used by a user of system 100 to visually inspect the chlorine levels within chiller water 106, and more specifically the sample within chlorine analysis center 200, from chiller water 106. If necessary, manual or automatic adjustments can then be made.

As discussed above, another output signal is sent from chlorine analyzer 260 via coupling line 265, to variable speed pump 280. Variable speed pump 180 then injects more or less of a Cal-Hypo Stock Solution into the “red water” system of the chiller 105 so that consistent free chlorine residuals can be obtained, measured, and recorded.

It is generally appreciated that the embodiments of the systems described herein are automated can thus software or other programmed hardware via firmware can be implemented to control the systems and methods. As such, the software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. An automatic control system for chlorine in chillers, the system comprising: a chiller tank for cooling food products;
a chlorine source coupled to the chiller tank; and
a chlorine analysis center coupled to the chiller tank and to the chlorine source.

2. The system as claimed in claim 1 wherein the chiller tank is coupled to the chlorine source via a water supply line.

3. The system as claimed in claim 1 wherein the chiller tank is coupled to the chlorine analysis center via a water sample line.

4. The system as claimed in claim 1 wherein the chlorine source and the chlorine analysis center are coupled via a signal line.

5. The system as claimed in claim 1 wherein the chlorine source comprises a supply line connected to a chlorinator and to a mixing tank.

6. The system as claimed in claim 5 further comprising a variable speed pump disposed between the mixing tank and the chiller tank.

6. The system as claimed in claim 6 further comprising a signal line disposed between the variable speed pump and the chlorine analysis center.

7. The system as claimed in claim 1 wherein the chlorine analysis center comprises: a chlorine analyzer coupled to the chlorine source; and
a debris tank coupled to the chiller tank and to the chlorine analyzer.

8. The system as claimed in claim 8 further comprising a pump disposed between the chlorine analyzer and the debris tank.

10. The system as claimed in claim 8 further comprising a centrifugal action filter disposed between the chlorine analyzer and the debris tank.

11. The system as claimed in claim 8 further comprising a flow meter disposed between the chlorine analyzer and the debris tank.

12. The system as claimed in claim 8 further comprising a flow cell disposed between the chlorine analyzer and the debris tank.

13. The system as claimed in claim 11 further comprising a chlorine probe disposed between the flow cell and the chlorine analyzer.

14. The system as claimed in claim 8 further comprising a chart recorder coupled to the chlorine analyzer.

15. The system as claimed in claim 8 further comprising a drain coupled to the debris tank for receiving sample water and debris overflow from the debris tank.

16. The system as claimed in claim 8 further comprising a compressed air source coupled to the debris tank for providing compressed air into a water sample contained within the debris tank.

17. A system for removing debris from a chlorine sample for testing of chlorine levels, the system comprising:
a chiller water tank;
means for providing chlorine to the chiller water tank; and
means for analyzing levels of chlorine contained within the chiller water tank.

18. The system as claimed in claim 17 further comprising means for varying a flow of chlorine into the chiller tank.

19. The system as claimed in claim 17 further comprising means for removing debris from water samples fed to the means for analyzing levels of chlorine contained within the chiller water tank.
